(19) United States
(12) Patent Application Publication
(10) Pub. No.: US 2024/0396121 A1
(43) Pub. Date: Nov. 28, 2024

(54) BATTERY COOLING DEVICE

(71) Applicant: Isuzu Motors Limited, Yokohama-shi, Kanagawa (JP)

(72) Inventor: Yuta IKEDA, Fujisawa-shi, Kanagawa (JP)

(73) Assignee: Isuzu Motors Limited, Yokohama-shi, Kanagawa (JP)

(21) Appl. No.: 18/693,663

(22) PCT Filed: Sep. 14, 2022
(86) PCT No.: PCT/JP2022/034324

§ 371 Date: Mar. 20, 2024

(30) Foreign Application Priority Data
Sep. 22, 2021 (JP) 2021-154310

(51) Int. Cl. H01M 10/6568; H01M 10/613; H01M 10/625; H01M 10/63; H01M 10/6556

(52) U.S. Cl. CPC H01M 10/6568; H01M 10/613; H01M 10/625; H01M 10/63; H01M 10/6556

(57) ABSTRACT

This battery cooling device comprises a unit heat sink set having a heat sink group wherein a plurality of heat sinks are connected in parallel, and a main flow tube connected to the heat sink group. The main flow tube has a connection portion that can be connected in a freely insertable and removable manner to the main flow pipe of another unit heat sink set, and a main flow regulating valve for regulating the flow rate of a refrigerant flowing from the main flow tube to the heat sink group.

### TECHNICAL FIELD

The present disclosure relates to a battery cooling device for cooling a battery mounted in a vehicle.

### BACKGROUND ART

As a battery cooling device of a vehicle, a device in which a heat sink (cooler) is provided so as to be adjacent to a battery has been known (e.g., see Patent Literature (hereinafter, referred to as PTL) 1). In the heat sink, a channel through which a refrigerant flows is formed, so that the heat of the battery can be lowered by the refrigerant.

### CITATION LIST

### Patent Literature

### PTL 1

Japanese Patent Application Laid-Open No. 2018-127087

### SUMMARY OF INVENTION

### Technical Problem

Incidentally, a capacity of a battery mounted in a vehicle is possibly changed. For example, to increase battery capacity, the battery is possibly replaced with the one having a large number of battery cells.

In response to the change in battery capacity, it is necessary to also change a configuration of a battery cooling device. In general, as battery capacity increases, a cooling capacity of a battery cooling device (e.g., the number of heat sinks) needs to be increased.

As a first method for changing a cooling capacity of a battery cooling device in response to a change in battery capacity, a method for restricting the operational range of the battery cooling device is considered, which involves pre-installing a battery cooling device with the capacity to cool the maximum possible battery capacity and adjusting the flow rate by closing a flow control valve or the like depending on the battery capacity.

Further, as a second method, a method for expanding the configuration of the battery cooling device (e.g., increasing the number of heat sinks) in response to an increase in battery capacity is considered.

However, the first method requires the installation of a battery cooling device with the capacity to cool the maximum possible battery capacity. Consequently, a larger-sized battery cooling device is unnecessarily equipped in a case where the battery capacity is not increased.

Further, regarding the second method, when expanding the configuration of the battery cooling device (increasing the number of heat sinks), it is necessary to finely adjust the flow rate between the existing and expanded sections to equalize the flow rate of the refrigerant supplied to the heat sink and to achieve uniform cooling over the entire battery, which results in complicating the configuration related to flow rate adjustment.

In particular, in a case where the battery capacity is often changed depending on the vehicle type as in the case of commercial vehicles, it is necessary to change the design of the battery cooling device or to finely adjust the flow rate of the refrigerant in each case.

The present disclosure has been made in consideration of the above points, and provides a battery cooling device capable of easily expanding the cooling capacity when the battery capacity is changed.

### Solution to Problem

One aspect of a battery cooling device of the present disclosure is a battery cooling device of a vehicle for cooling a battery by using a heat sink including a channel formed therein and through which a refrigerant flows, and the battery cooling device including:
a unit heat sink set including:
   a heat sink group in which a plurality of the heat sinks is connected in parallel; and
   a main pipe connected to the heat sink group, in which
the main pipe includes:
   a connecting section capable of removably connecting a main pipe of another unit heat sink set; and
   a main flow control valve for adjusting a flow rate of the refrigerant flowing from the main pipe to the heat sink group.

### Advantageous Effects of Invention

According to the present disclosure, a cooling capacity can be easily expanded even when a battery capacity is changed.

### BRIEF DESCRIPTION OF DRAWINGS

FIG. 1 is a diagram for describing a main configuration of a battery cooling device according to an embodiment;

FIG. 2 illustrates a state in which an additional heat sink set is connected in series to the subsequent stage of a heat sink set;

FIG. 3 is a perspective view of an exemplary configuration of a connecting section;

FIG. 4 is a schematic perspective view of an exemplary configuration of a heat sink according to the embodiment;

FIG. 5 is a schematic perspective view of the heat sink;

FIG. 6 is a schematic perspective view of an example in which the folded widths of unit channels are the same as a cell width; and

FIG. 7 illustrates another embodiment.

### DESCRIPTION OF EMBODIMENTS

Hereinafter, an embodiment of the present disclosure will be described in detail with reference to the drawings. A battery and a battery cooling device of the present embodiment are mounted in a vehicle.

### <Overall Configuration of Battery Cooling Device>

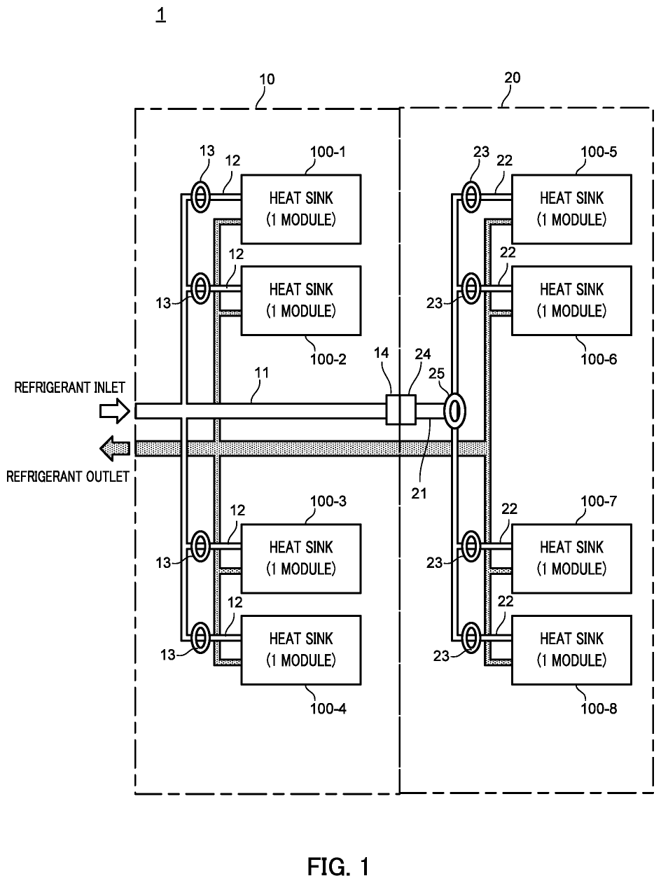

FIG. 1 is a diagram for describing a main configuration of battery cooling device 1 according to an embodiment.

The cooling capacity of battery cooling device 1 can be increased in response to an increase in battery capacity by connecting a plurality of unit heat sink sets 10 and 20.

In the case of FIG. 1, heat sink set 10 is originally mounted, and heat sink set 20 is connected in series to heat sink set 10 in response to an increase in battery capacity. Note that, in the present embodiment, heat sinks 100-1 to 100-8 constituting heat sinks 10 and 20 are each implemented by a separate module.

Each module (that is, each of heat sinks 100-1 to 100-8) may cool a separate battery pack. Alternatively, each module (that is, each of heat sinks 100-1 to 100-8) may cool each area obtained by dividing the area of one battery pack.

Heat sink set 10 includes heat sink groups 100-1 to 100-4, main pipe 11, branch pipe 12, branch flow control valve 13, and connecting section 14. Heat sink groups 100-1 to 100-4 are connected in parallel to each other. Into main pipe 11, a refrigerant such as pure water or a fluorine-based inert liquid flows from a refrigerant supply device (not illustrated). The refrigerant in main pipe 11 is supplied to heat sink groups 100-1 to 100-4.

Heat sink set 20 includes heat sink groups 100-5 to 100-8, main pipe 21, branch pipe 22, branch flow control valve 23, connecting section 24, and main flow control valve 25. Heat sink groups 100-5 to 100-8 are connected in parallel to each other.

The refrigerant can be supplied to heat sink set 20 by connecting connecting section 24 of heat sink set 20 to connecting section 14 of heat sink set 10.

Further, the flow rate of the refrigerant supplied to heat sink groups 100-5 to 100-8 included in heat sink set 20 can be collectively adjusted based on a degree of opening of main flow control valve 25. For example, the degree of opening of main flow control valve 25 is adjusted based on the number of heat sinks included in heat sink groups 100-5 to 100-8 of unit heat sink set 20 (four in the example of FIG. 1).

This allows the refrigerant to be supplied to all of heat sinks 100-1 to 100-8 at the same speed without fine adjustment. For example, the refrigerant can be supplied to all of heat sinks 100-1 to 100-8 at the same speed only by the degree of opening of main flow control valve 25 even in a state where branch flow control valves 13 and 23 are not finely adjusted and all of these valves are fully opened.

Note that the channel illustrated with shading in FIG. 1 is the channel for the refrigerant after being used to cool heat sinks 100-1 to 100-8.

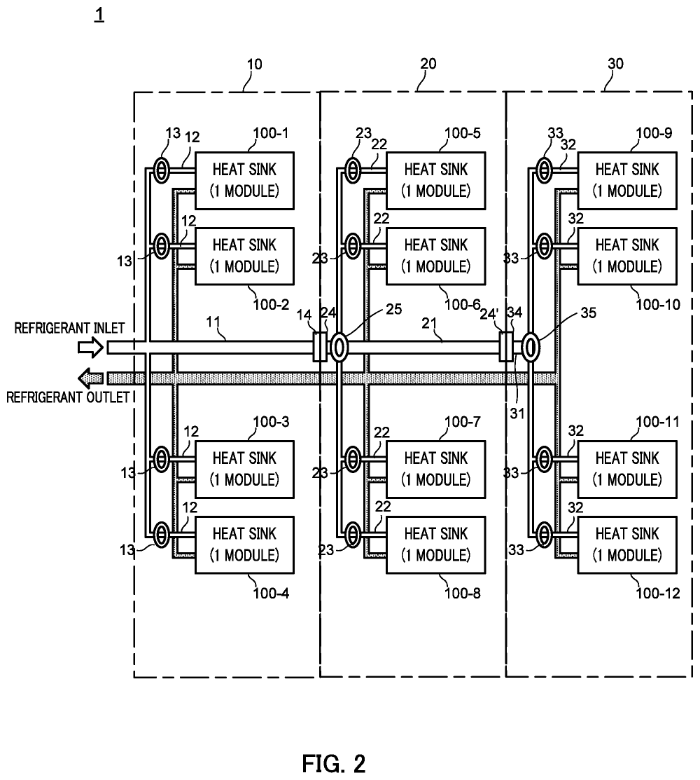

FIG. 2 illustrates a state in which seat sink set 30 is further connected in series to the subsequent stage of heat sink set 20 in response to an increase in battery capacity.

Similarly to heat sink set 20, heat sink set 30 includes heat sink groups 100-9 to 100-12, main pipe 31, branch pipe 32, branch flow control valve 33, connecting section 34, and main flow control valve 35. Heat sink groups 100-9 to 100-12 are connected in parallel to each other.

The refrigerant can be supplied to heat sink set 30 by connecting connecting section 34 of heat sink set 30 to connecting section 24 of heat sink set 20.

Further, the flow rate of the refrigerant supplied to heat sink groups 100-9 to 100-12 included in heat sink set 30 can be collectively adjusted based on a degree of opening of main flow control valve 35. For example, the degree of opening of main flow control valve 35 is adjusted based on the number of heat sinks included in heat sink groups 100-9 to 100-12 of unit heat sink set 30 (four in the example of FIG. 2).

Undoubtedly, an additional heat sink set (not illustrated) may be connected in series to the subsequent stage of heat sink set 30.

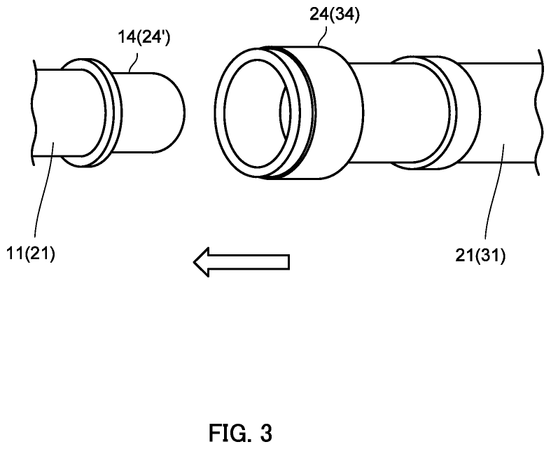

FIG. 3 is a perspective view of an exemplary configuration of connecting sections 14, 24, 24′, and 34. It is preferred that connecting sections 14, 24, 24′, and 34 each be formed as a quick connector as illustrated. By using quick connectors, main pipes 11, 21, and 31 can be easily connected in series.

Note that, although FIGS. 1 and 2 illustrate connecting sections 14, 24, 24′, and 34 of the main pipes on the refrigerant inlet side, in practice, it is preferred to provide similar connecting sections (not illustrated) to the main pipes on the refrigerant outlet side.

However, the main pipes on the refrigerant outlet side do not necessarily need to be connected in series.

### <Configuration of Heat Sink>

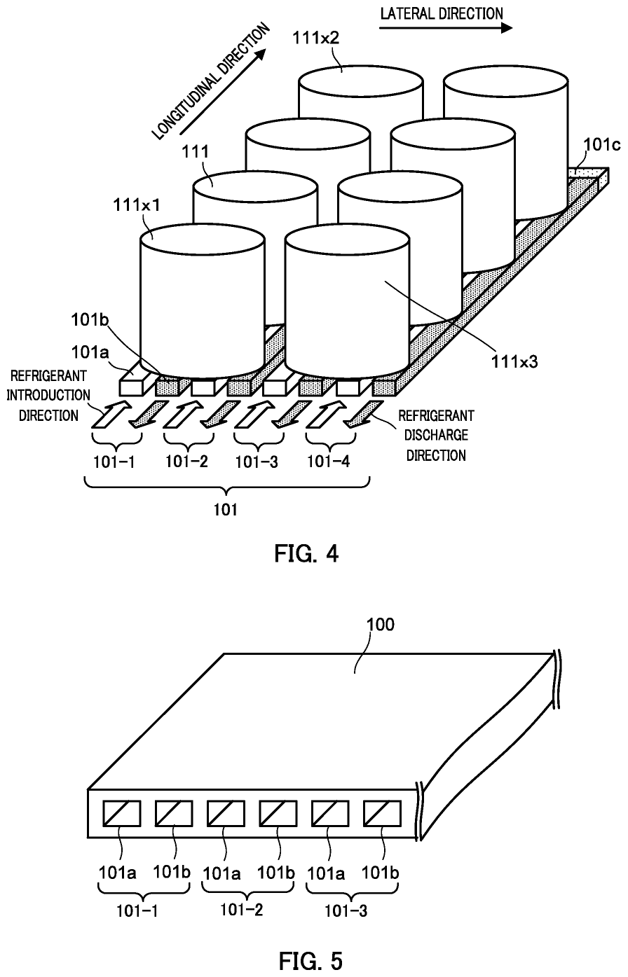

Next, the configuration of each heat sink 100 (100-1 to 100-12) will be described in detail with reference to FIGS. 4 to 6.

The battery includes a battery pack (not illustrated) and a plurality of battery cells 111 disposed in the battery pack. Each heat sink 100 includes channel 101 as illustrated in FIGS. 4 and 5. In the present embodiment, each heat sink 100 is disposed on the lower surface of the battery so as to adjacent to the battery.

In practice, channel 101 of heat sink 100 is formed by, for example, performing extrusion on an aluminum plate.

In the present embodiment, a plurality of unit channels 101-1, 101-2, 101-3, 101-4, and so forth is formed in heat sink 100. Each of unit channels 101-1, 101-2, 101-3, 101-4, and so forth has a U-shape formed by folding to have a width equal to or shorter than the cell width of battery cell 111. In practice, unit channels 101-1, 101-2, 101-3, 101-4, and so forth each have outward channel 101a, return channel 101b, and turning-back channel 101c.

Each of unit channels 101-1, 101-2, 101-3, 101-4, and so forth has a U-shape formed by folding to have a width equal to or shorter than the cell width of battery cell 111, so that one or more unit channels 101-1, 101-2, 101-3, 101-4, and so forth pass through each battery cell 111.

FIG. 4 illustrates an example in which the folded widths of unit channels 101-1, 101-2, 101-3, 101-4, and so forth are approximately ½ of the cell width. In this case, two of unit channels 101-1, 101-2, 101-3, 101-4, and so forth can pass through one battery cell 111.

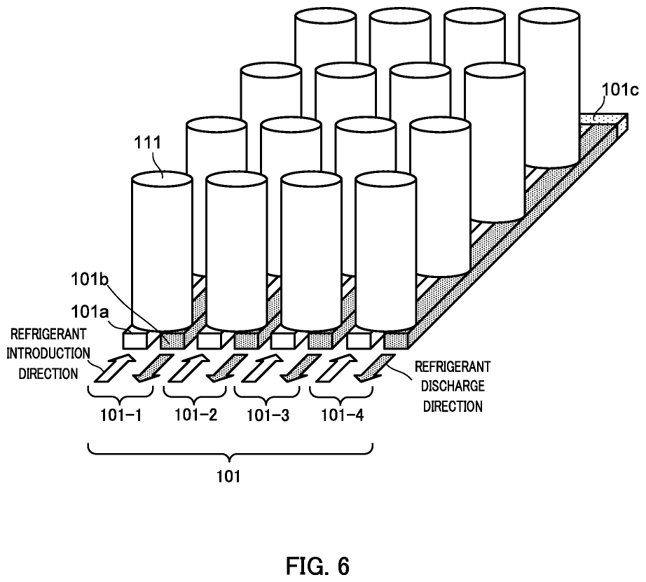

FIG. 6 illustrates an example in which the folded widths of unit channels 101-1, 101-2, 101-3, 101-4, and so forth are the same as the cell width. In this case, one of unit channels 101-1, 101-2, 101-3, 101-4, and so forth can pass through one battery cell 111.

As can be seen from FIGS. 4 and 6, the battery is configured by arranging a plurality of battery cells 111 in the battery pack in the longitudinal and lateral directions, unit channels 101-1, 101-2, 101-3, 101-4, and so forth each extend over the plurality of battery cells 111 in the longitudinal direction, and the plurality of unit channels is formed in the lateral direction. Further, one or more unit channels 101-1, 101-2, 101-3, 101-4, and so forth are formed for each battery cell in the lateral direction. Specifically, in the example of FIG. 4, two of unit channels 101-1, 101-2, 101-3, 101-4, and so forth are formed for each battery cell in the lateral direction, and in the example of FIG. 6, one of unit channels 101-1, 101-2, 101-3, 101-4, and so forth is formed for each battery cell in the lateral direction.

The refrigerant before cooling battery cells 111 flows from one end of each of unit channels 101-1, 101-2, 101-3, 101-4, . . . , and the refrigerant after cooling battery cells 111 is discharged from the other end. In practice, the refrigerant flows into one end of each of unit channels 101-1, 101-2, 101-3, 101-4, and so forth through branch pipes 12, 22, and 32.

Since heat sink 100 of the present embodiment includes such unit channels 101-1, 101-2, 101-3, 101-4, and so forth, battery cells 111 can be cooled to approximately the same temperature regardless of the positions in the longitudinal and lateral directions. A description is given of this point with reference to FIG. 4.

First, the temperatures of battery cells 111 in the longitudinal direction will be described. As extreme cases, the temperature of battery cell 111x1 located at the position closest to the refrigerant inlet/outlet and the temperature of battery cell 111x2 located at the position closest to turning-back channel 101c are compared.

For battery cell 111x1, the refrigerant having the lowest temperature passes through outward channel 101a, and the refrigerant having the highest temperature passes through return channel 101b. Thus, it can be said that the cooling effect on battery cell 111x1 is moderate.

Meanwhile, for battery cell 111x2, the refrigerant having the highest temperature passes though outward channel 101a, and the refrigerant having the lowest temperature passes through return channel 101b. Thus, it can be said that the cooling effect on battery cell 111x2 is moderate.

Therefore, the cooling of battery cell 111x1 and the cooling of battery cell 111x2 are performed to the same extent, and unevenness of temperature in the longitudinal direction does not occur.

Next, the temperatures of battery cells 111 in the lateral direction will be described. The temperature of battery cell 111x1 and the temperature of battery cell 111x3 are compared, for example.

Through both battery cell 111x1 and battery cell 111x3, the same numbers of outward channels 101a and return channels 101b pass, and thus the cooling of battery cell 111x1 and the cooling of battery cell 111x3 are performed to the same extent. Therefore, unevenness of temperature in the lateral direction does not occur.

Accordingly, unit channels 101-1, 101-2, 101-3, 101-4, and so forth each having a U-shape formed by folding to have a width equal to or shorter than the cell width of battery cell 111 are formed in heat sink 100, and therefore, unevenness of temperature between battery cells 111 can be reduced, which extends the battery life.

### Summary

As described above, according to the present embodiment, a battery cooling device of a vehicle for cooling a battery by using heat sink 100 including channel 101 formed therein and through which a refrigerant flows comprises heat sink sets 10, 20, and 30 respectively including: heat sink groups 100-1 to 100-4, 100-5 to 100-8, and 100-9 to 100-12 in which a plurality of heat sinks 100 is connected in parallel; and main pipes 11, 21, and 31 respectively connected to heat sink groups 100-1 to 100-4, 100-5 to 100-8, and 100-9 to 100-12. Main pipes 11, 21, and 31 include: connecting sections 14, 24, 24′, and 34 capable of removably connecting the main pipe of another unit heat sink set; and main flow control valves 25 and 35 for adjusting a flow rate of the refrigerant flowing from main pipes 11, 21, and 31 to heat sink groups 100-1 to 100-4, 100-5 to 100-8, and 100-9 to 100-12, respectively.

Thus, heat sink 100 can be easily added by simply connecting main pipes 21 and 31 in series, and the flow rates of heat sink groups 100-1 to 100-4, 100-5 to 100-8, 100-9 to 100-12 and heat sink groups 100-1 to 100-4, 100-5 to 100-8, 100-9 to 100-12 can be easily adjusted to be the same rate by simply adjusting the main flow control valves 25 and 35.

Therefore, it is possible to realize a battery cooling device capable of easily expanding a cooling capacity even when a battery capacity is changed.

The above-described embodiment merely describes an example of specific implementation for practicing the present disclosure, and should not be construed as limiting the technical scope of the present disclosure. That is, the present disclosure can be carried out in various forms without departing from the spirit and the main features thereof.

In the above-described embodiment, each of unit channels 101-1, 101-2, 101-3, 101-4, and so forth has been described as having a U-shape formed by folding to have a width equal to or shorter than the cell width, but the present disclosure is not limited thereto, and each of unit channels 101-1, 101-2, 101-3, 101-4, and so forth may have two or more U-shapes. That is, each of unit channels 101-1, 101-2, 101-3, 101-4, and so forth may be folded twice or more times. However, it is preferred that each of unit channels 101-1, 101-2, 101-3, 101-4, and so forth fit within one cell width. Thus, it is preferred that the folded width be ½ of the cell width when the unit channel is folded twice, and that the folded width be ⅓ of the cell width when the unit channel is folded three times.

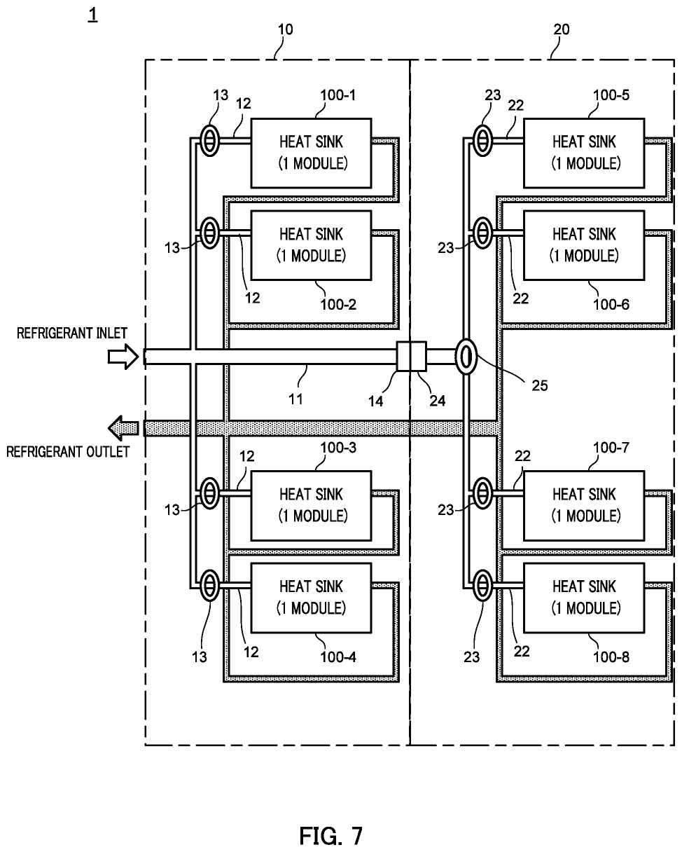

In the above-described embodiment, a case has been described in which unevenness of temperature between battery cells 111 is reduced by forming, in heat sink 100, unit channels 101-1, 101-2, 101-3, 101-4, and so forth each having a U-shape formed by folding to have a width equal to or shorter than the cell width of battery cell 111, but the shape of the channel of heat sink 100 is not limited thereto. For example, the present disclosure is also applicable to heat sink 100 in which a channel flowing in one direction is formed as illustrated in FIG. 7, in which the same reference numerals are added to the components corresponding to those in FIG. 1.

The disclosure of Japanese Patent Application No. 2021-154310, filed on Sep. 22, 2021, including the specification, drawings and abstract, is incorporated herein by reference in its entirety.

### INDUSTRIAL APPLICABILITY

The present disclosure is useful as a battery cooling device of a vehicle in which the mounted battery capacity is variable.

### REFERENCE SIGNS LIST

1 Battery cooling device
10, 20, 30 Heat sink set
11, 21, 31 Main pipe
12, 22, 32 Branch pipe
13, 23, 33 Branch flow control valve
14, 24, 24′, 34 Connecting section
25, 35 Main flow control valve
100 (100-1 to 100-12) Heat sink
101 Channel
101-1, 101-2, 101-3, 101-4 Unit channel
101a Outward channel
101b Return channel
101c Turning-back channel
111, 111x1, 111x2, 111x3 Battery cell

1. A battery cooling device of a vehicle for cooling a battery by using a heat sink including a channel formed therein and through which a refrigerant flows, the battery cooling device comprising:
a unit heat sink set including:
a heat sink group in which a plurality of the heat sinks is connected in parallel; and
a main pipe connected to the heat sink group, wherein
the main pipe includes:
a connecting section capable of removably connecting a main pipe of another unit heat sink set; and
a main flow control valve for adjusting a flow rate of the refrigerant flowing from the main pipe to the heat sink group.

2. The battery cooling device according to claim 1, wherein
a plurality of branch pipes are each provided with a branch flow control valve for adjusting a flow rate of the plurality of branch pipes, the plurality of branch pipes connecting between the main pipe and the plurality of heat sinks connected in parallel.

3. The battery cooling device according to claim 1, wherein
a degree of opening of the main flow control valve is adjusted based on a number of heat sinks included in the heat sink group of the unit heat sink set to which the main flow control valve belongs.

4. The battery cooling device according to claim 1, wherein
the channel formed in the heat sink includes a unit channel in which the refrigerant before cooling a battery cell flows from one end of the unit channel and the refrigerant after cooling the battery cell is discharged from another end of the unit channel, and
the unit channel has a U-shape formed by folding to have a width equal to or shorter than a cell width of the battery cell.
